(19) United States
(12) Patent Application Publication
(10) Pub. No.: US 2025/0320121 A1
(43) Pub. Date: Oct. 16, 2025

(54) METHOD OF MANUFACTURING NEGATIVE ELECTRODE ACTIVE MATERIAL, NEGATIVE ELECTRODE ACTIVE MATERIAL MANUFACTURED USING THE SAME, RECHARGEABLE LITHIUM BATTERY INCLUDING THE SAME

(71) Applicant: SAMSUNG SDI CO., LTD., Yongin-si, Gyeonggi-do (KR)

(72) Inventor: CHUL YOUM, Yongin-si (KR)

(21) Appl. No.: 19/091,608

(22) Filed: Mar. 26, 2025

(30) Foreign Application Priority Data
Apr. 12, 2024 (KR) 10-2024-0049309

(51) Int. Cl. C01B 32/05; H01M 10/0525

(52) U.S. Cl. CPC C01B 32/05; H01M 10/0525; C01P 2004/03; C01P 2004/61; C01P 2004/84; C01P 2006/40

(57) ABSTRACT

Disclosed are methods of manufacturing negative electrode active materials, negative electrode active materials manufactured using the same, and rechargeable lithium batteries including the same. The method of manufacturing a negative electrode active material comprises mixing a silicon-iron alloy and a hard carbon raw material together to prepare a first mixture, allowing the first mixture to undergo graphitization at about 1,000° C. to about 1,500° C. to prepare a second mixture, and washing the second mixture with an acid.

### CROSS-REFERENCE TO RELATED APPLICATION

The present application claims priority to and the benefit of Korean Patent Application No. 10-2024-0049309, filed on Apr. 12, 2024, in the Korean Intellectual Property Office, the entire content of which is hereby incorporated by reference.

### BACKGROUND

### 1. Field

Embodiments of the present disclosure relate to a method of manufacturing a negative electrode active material, a negative electrode active material manufactured using the same, and a rechargeable lithium battery including the same.

### 2. Description of the Related Art

Recently, with the rapid spread of battery using electronic devices, such as mobile phones, laptop computers, and electric vehicles, there is a rapidly increasing demand for rechargeable batteries having high energy density and high capacity. Therefore, intensive research has been conducted to improve performance of rechargeable lithium batteries.

A rechargeable lithium battery includes a positive electrode, a negative electrode, and an electrolyte, which positive and negative electrodes include an active material in which intercalation and deintercalation are possible, and generates electrical energy caused by oxidation and reduction reactions if lithium ions are intercalated and deintercalated.

### SUMMARY

An embodiment of the present disclosure provides a method of manufacturing a negative electrode active material capable of easily shrinking, maintaining its structure despite a volume change during charge and discharge, and having a low resistance (e.g., a low electrical resistance), and a negative electrode active material manufactured using the same.

An embodiment of the present disclosure provides a rechargeable lithium battery having excellent capacity and long lifetime.

According to an embodiment of the present disclosure, a method of manufacturing a negative electrode active material may include: mixing a silicon-iron alloy and a hard carbon raw material together to prepare a first mixture; allowing the first mixture to undergo graphitization (e.g., graphitizing the first mixture) at about 1,000° C. to about 1,500° C. to prepare a second mixture; and washing the second mixture with an acid.

According to an embodiment of the present disclosure, a negative electrode active material may include: a core that includes a first crystalline carbon and a porous silicon particle; and a shell on the core. A size of the core may be in a range of about 1 μm to about 20 μm. The shell may include: a first shell on the core; and a second shell on the first shell. The first shell may include an amorphous carbon. The second shell may include a second crystalline carbon.

According to an embodiment of the present disclosure, a rechargeable lithium battery may include the negative electrode active material.

### BRIEF DESCRIPTION OF DRAWINGS

The accompanying drawings, together with the specification, illustrate embodiments of the subject matter of the present disclosure, and, together with the description, serve to explain principles of embodiments of the subject matter of the present disclosure.

FIG. 1 is a simplified conceptual diagram showing a rechargeable lithium battery according to an embodiment of the present disclosure.

FIGS. 2-5 are simplified diagrams showing rechargeable lithium batteries according to embodiments of the present disclosure, with FIG. 2 showing a cylindrical battery, FIG. 3 showing a prismatic battery, and FIGS. 4-5 showing pouch-type batteries.

FIG. 6 is a cross-sectional view showing a negative electrode for a rechargeable lithium battery according to an embodiment of the present disclosure.

FIG. 7 is a cross-sectional view showing a negative electrode active material according to an embodiment of the present disclosure.

FIG. 8 is a cross-sectional view showing a porous silicon particle according to an embodiment of the present disclosure.

FIG. 9 is a flow chart showing a method of manufacturing a negative electrode active material according to an embodiment of the present disclosure.

FIGS. 10-12 are diagrams showing the method of manufacturing a negative electrode active material according to an embodiment of the present disclosure.

FIG. 13 is an SEM image showing a negative electrode active material according to Embodiment 1.

FIG. 14 is an SEM image showing a negative electrode active material according to Comparative Example 1.

FIG. 15 is an SEM image showing a negative electrode active material according to Comparative Example 2.

FIG. 16 is an SEM image showing a negative electrode active material according to Comparative Example 3.

FIG. 17 is an SEM image showing a negative electrode active material according to Comparative Example 5.

FIG. 18 is an SEM image showing a negative electrode active material according to Comparative Example 6.

### DETAILED DESCRIPTION

In order to sufficiently understand the configuration and effect of the subject matter of the present disclosure, some embodiments of the present disclosure will be described with reference to the accompanying drawings. It should be noted, however, that the present disclosure is not limited to the following example embodiments, and may be implemented in various suitable forms. Rather, the example embodiments are provided herein only to disclose the subject matter of the present disclosure and let those of ordinary skill in the art fully know the scope of the present disclosure.

In this description, it will be understood that, if an element is referred to as being on another element, the element can be directly on the other element or intervening elements may be present between therebetween. In the drawings, thicknesses of some components may be exaggerated to effectively explain the technical contents of the present disclosure. Like reference numerals refer to like elements throughout the specification.

Unless otherwise specially noted in this description, the expression of a singular form may include the expression of a plural form. In embodiments, unless otherwise specially noted, the phrase “A or B” may indicate “A but not B”, “B but not A”, and “A and B”. The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, and/or a reaction product.

Unless otherwise especially defined in this description, a particle diameter may be an average particle diameter. In embodiments, a particle diameter indicates an average particle diameter (D₅₀) where a cumulative volume is about 50 vol % in a particle size distribution. The average particle diameter (D₅₀) may be measured by any suitable method generally used in the art, for example, by a particle size analyzer, a transmission electron microscope (TEM) image, and/or a scanning electron microscope (SEM) image. In embodiments, a dynamic light-scattering measurement device is used to perform a data analysis, the number of particles is counted for each particle size range, and then from this, an average particle diameter (D₅₀) value may be obtained through a calculation. In embodiments, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

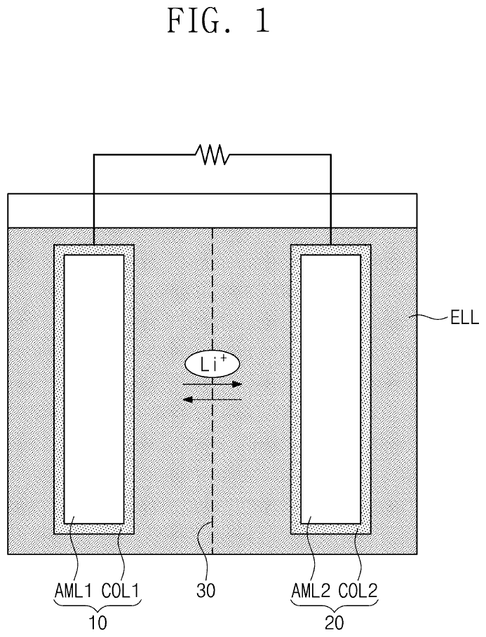

FIG. 1 is a simplified conceptual diagram showing a rechargeable lithium battery according to an embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 or the negative electrode 20.

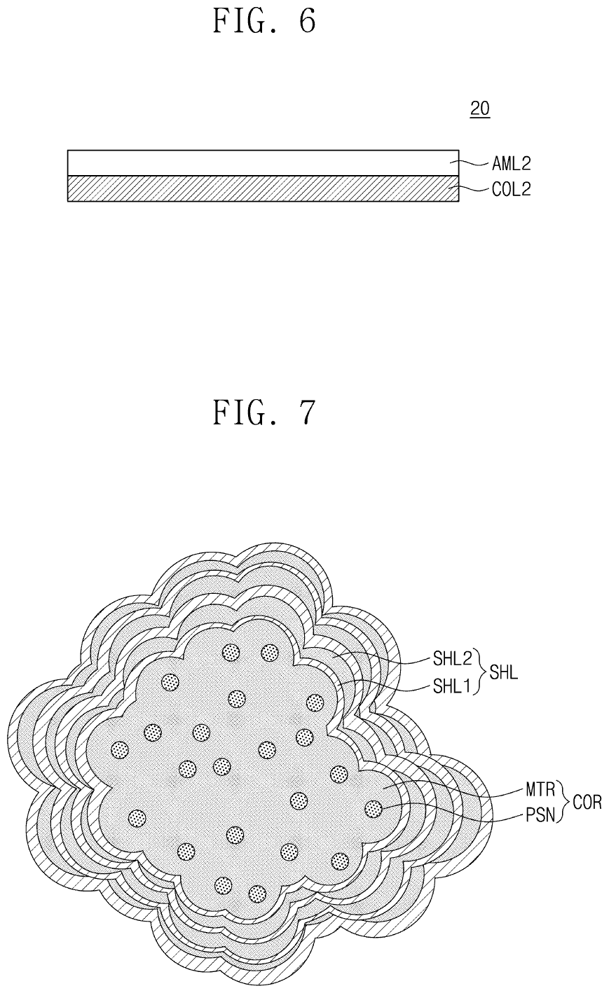

The negative electrode 20 will be further discussed below with reference to FIG. 6.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and further include a binder and/or a conductive material (e.g., an electrically conductive material).

For example, the positive electrode 10 may further include an additive that can serve as a sacrificial positive electrode.

An amount of the positive electrode active material may be about 90 wt % to about 99.5 wt % relative to 100 wt % of the positive electrode active material layer AML1. An amount of each of the binder and the conductive material may be about 0.5 wt % to about 5 wt % relative to 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and/or nylon, but the present disclosure is not limited thereto.

The conductive material may be used to provide an electrode with conductivity (e.g., electrical conductivity), and any suitable conductive material without causing chemical change of a battery (e.g., that does not cause an undesirable chemical change in the rechargeable lithium battery) may be used as the conductive material to constitute the battery. The conductive material may include, for example, a carbon-based material such as natural graphite, artificial graphite, carbon black, acetylene black, Ketjenblack, carbon fiber, carbon nano-fiber, and/or carbon nano-tube (e.g., SWCNT or multi-wall CNT); a metal powder and/or metal fiber including one or more of copper, nickel, aluminum, and/or silver; a conductive polymer (e.g., an electrically conductive polymer) such as a polyphenylene derivative; or a mixture thereof.

Aluminum (Al) may be used as the current collector COL1, but the present disclosure is not limited thereto.

For example, the current collector COL1 may have substantially the same area as that of the positive electrode active material layer AML1. In this description, the expression “substantially the same area” may refer to less than 10 percent difference between two areas. For another example, the current collector COL1 may have a different area from that of the positive electrode active material layer AML1. In this description, the expression “different area” may refer to more than 10 percent difference between two areas. For example, the current collector COL1 may have a larger area than that of the positive electrode active material layer AML1.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is selected from cobalt, manganese, nickel, and a combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound represented by one selected from chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{α}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn₁₋₆G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); and LiₐFePO₄ (where 0.90≤a≤1.8).

In the chemical formulae above, A is Ni, Co, Mn, or a combination thereof, X is Al, Ni, Co, Mn, Cr, Fe, Mg, Sr, V, a rare-earth element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

For example, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density rechargeable lithium battery (e.g., a high-capacity and a high-energy-density rechargeable lithium battery).

### Separator 30

Based on a type (or kind) of the rechargeable lithium battery, the separator 30 may be present between the positive electrode 10 and the negative electrode 20. The separator 30 may include one or more selected from polyethylene, polypropylene, and polyvinylidene fluoride, and may have a multi-layered separator thereof such as a polyethylene/polypropylene bi-layered separator, a polyethylene/polypropylene/polyethylene tri-layered separator, and/or a polypropylene/polyethylene/polypropylene tri-layered separator.

The separator 30 may include a porous substrate and a coating layer on one or opposite surfaces (e.g., two opposing surfaces) of the porous substrate, which coating layer includes an organic material, an inorganic material, or a combination thereof.

The porous substrate may be a polymer layer including one selected from polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including two or more selected from the materials mentioned above.

The organic material may include a polyvinylidenefluoride-based copolymer and/or a (meth)acrylic copolymer.

The inorganic material may include an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be present mixed together in one coating layer or may be present as a stack of a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may serve as a medium that transmits ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2,5-dimethyltetrahydrofuran, and/or tetrahydrofuran. The ketone-based solvent may include cyclohexanone. The alcohol-based solvent may include ethyl alcohol or isopropyl alcohol. The aprotic solvent may include nitriles such as R—CN (where R is a hydrocarbon group having a C2 to C20 linear, branched, or cyclic structure and may include a double bond, an aromatic ring, and/or an ether group); amides such as dimethylformamide; dioxolanes such as 1,3-dioxolane and/or 1,4-dioxolane; and/or sulfolanes.

The non-aqueous organic solvent may be used alone or in a mixture of two or more substances.

In embodiments, if a carbonate-based solvent is used, a cyclic carbonate and a chain carbonate may be mixed together and used, and the cyclic carbonate and the chain carbonate may be mixed together in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFBOP), and lithium bis(oxalato)borate (LiBOB).

### Rechargeable Lithium Battery

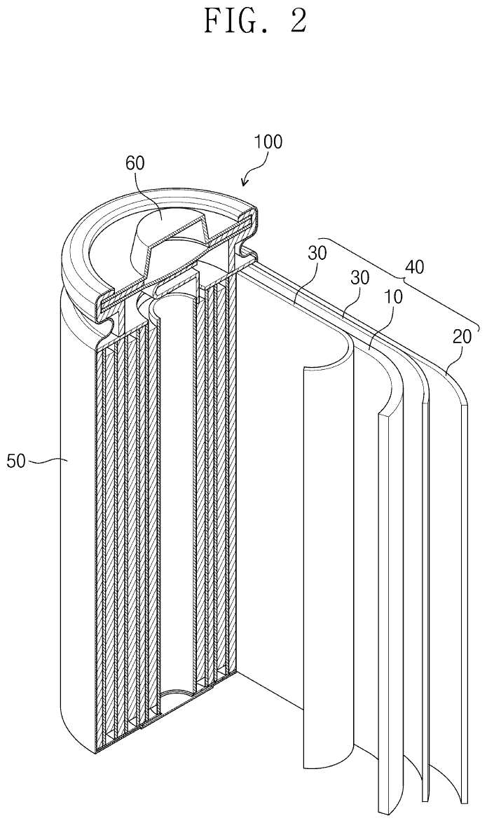

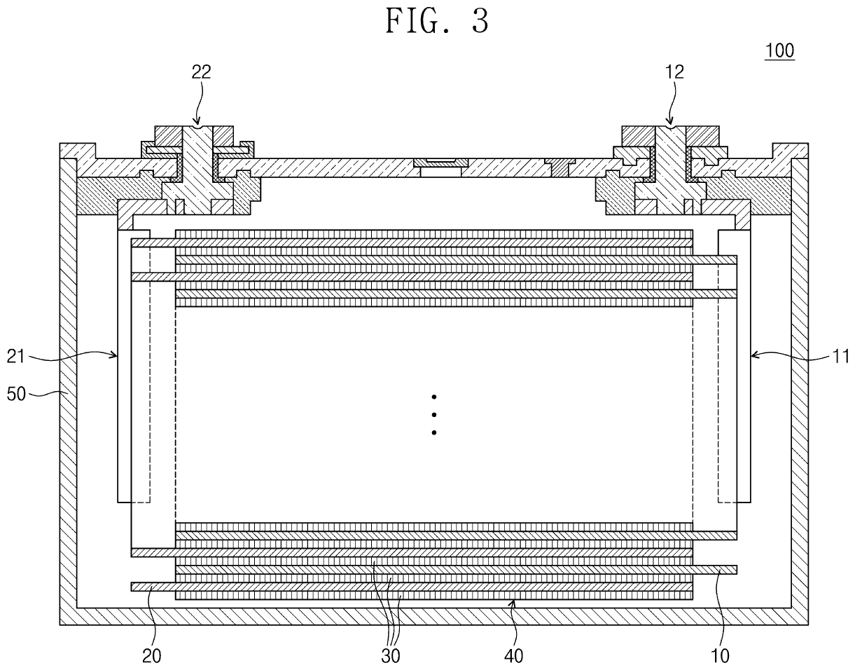

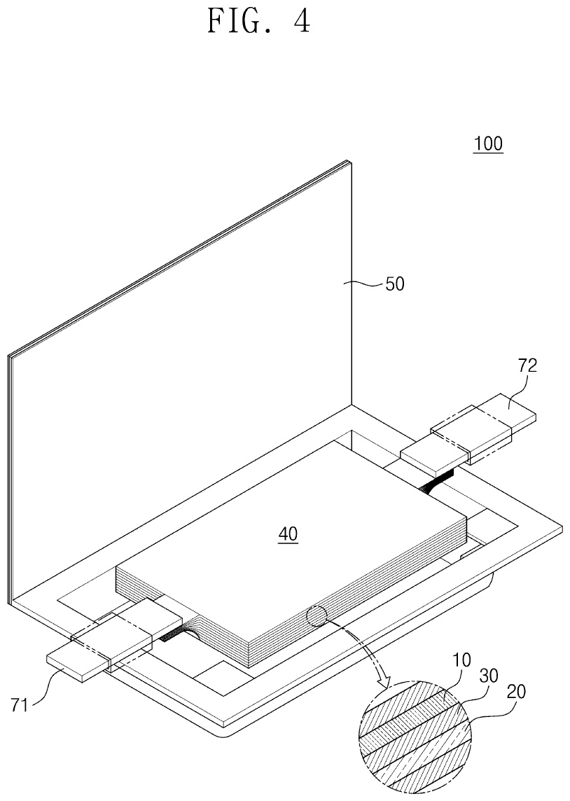

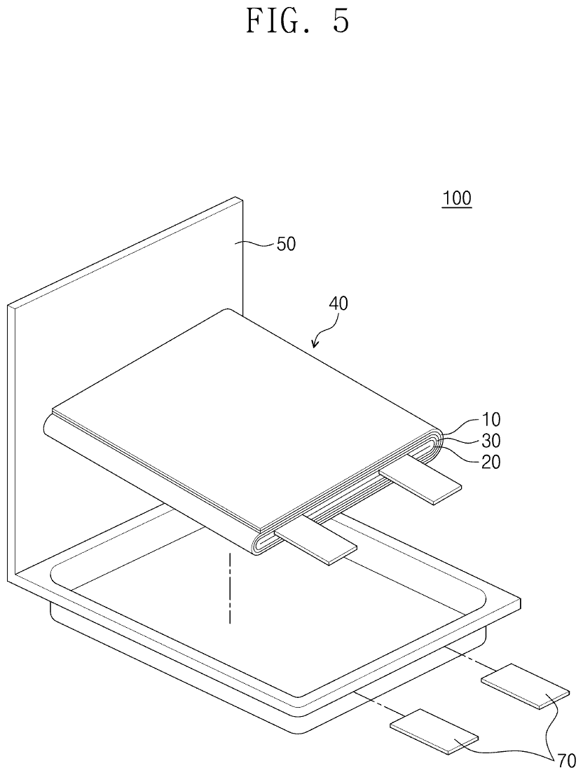

Based on a shape of a rechargeable lithium battery, the rechargeable lithium battery may be classified into cylindrical, prismatic, pouch, and/or coin types (kinds). FIGS. 2-5 are simplified diagrams showing a rechargeable lithium battery according to an embodiment, with FIG. 2 showing a cylindrical battery, FIG. 3 showing a prismatic battery, and FIGS. 4-5 showing pouch-type batteries. Referring to FIGS. 2-5, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated with an electrolyte. The rechargeable lithium battery 100 may include a sealing member 60 that seals the casing 50 as illustrated in FIG. 2.

In embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4-5, the rechargeable lithium battery 100 may include an electrode tab 70 (FIG. 5), or a positive electrode tab 71 and a negative electrode tab 72 (FIG. 4), which electrode tabs 70/71/72 serve as an electrical path for externally inducing a current generated in the electrode assembly 40.

A rechargeable lithium battery according to an embodiment of the present disclosure may be applied to automotive vehicles, mobile phones, and/or any other suitable electrical devices, but the present disclosure is not limited thereto.

FIG. 6 is a cross-sectional view showing the negative electrode 20 according to an embodiment of the present disclosure. Referring to FIG. 6, the negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive material (e.g., an electrically conductive material).

For example, the negative electrode active material layer AML2 may include a negative electrode active material of about 90 wt % to about 99 wt %, a binder of about 0.5 wt % to about 5 wt %, and a conductive material (e.g., an electrically conductive material) of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof. The aqueous binder may include styrene-butadiene rubber, (meth)acrylated

styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly (meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

If an aqueous binder is used as the negative electrode binder, a cellulose-based compound capable of providing or increasing viscosity may further be included. The cellulose-based compound may include one or more selected from carboxymethyl cellulose, hydroxypropylmethyl cellulose, methyl cellulose, and alkali metal salts thereof. The alkali metal may include Na, K, and/or Li.

The dry binder may include a fibrillizable polymer material, for example, polytetrafluoroethylene, polyvinylidene fluoride, polyvinylidene fluoride-hexafluoropropylene copolymer, polyethylene oxide, or a combination thereof.

The conductive material may be used to provide an electrode with conductivity (e.g., electrical conductivity), and any suitable conductive material without causing chemical change of a battery (e.g., that does not cause an undesirable chemical change in a rechargeable lithium battery) may be used as the conductive material to constitute the battery. For example, the conductive material may include a carbon-based material such as natural graphite, artificial graphite, carbon black, acetylene black, Ketjenblack, carbon fiber, carbon nano-fiber, and/or carbon nano-tube; a metal powder and/or metal fiber including one or more selected from copper, nickel, aluminum, and silver; a conductive polymer (e.g., an electrically conductive polymer) such as a polyphenylene derivative; or a mixture thereof.

The current collector COL2 may include a copper foil, a nickel foil, a stainless-steel foil, a titanium foil, a nickel foam, a copper foam, a polymer substrate coated with a conductive metal (e.g., an electrically conductive metal), or a combination thereof.

For example, the current collector COL2 may have substantially the same area as that of the negative electrode active material layer AML2. In embodiments, the current collector COL2 may have a different area from that of the negative electrode active material layer AML2. For example, the current collector COL2 may have a larger area than that of the negative electrode active material layer AML2.

### Negative Electrode Active Material

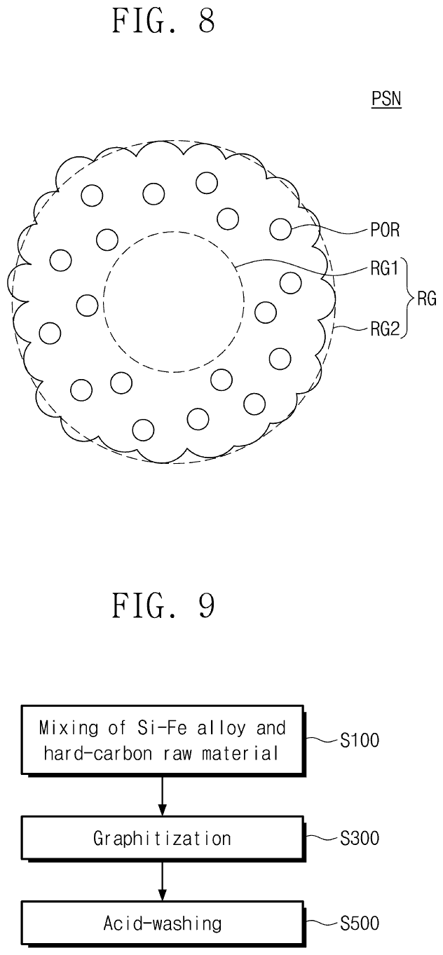

FIG. 7 is a cross-sectional view showing a negative electrode active material according to an embodiment of the present disclosure. FIG. 8 is a cross-sectional view showing a porous silicon particle of a negative electrode active material according to an embodiment of the present disclosure.

Referring to FIG. 7, a negative electrode active material according to an embodiment of the present disclosure may include a core COR and a shell SHL on the core COR.

The core COR may have a size in a range from about 1 μm to about 20 μm or from about 1 μm to about 10 μm. For example, the size of the core COR may refer to a diameter obtained by measuring 30 or more cores COR randomly selected from an electron microscope image of the negative electrode active material. For example, the diameter may include a major-axis length and/or a minor-axis length.

The core COR may include a first crystalline carbon MTR and a porous silicon particle PSN.

The first crystalline carbon MTR may include at least one selected from natural graphite and artificial graphite. For example, the first crystalline carbon MTR may be natural graphite, artificial graphite, or any combination thereof. The first crystalline carbon MTR may have an electronic resistance less than that of amorphous carbon. Thus, electrons may easily move between the first crystalline carbon MTR and the porous silicon particle PSN.

For example, the first crystalline carbon MTR may have a D/G value of equal to or less than about 0.2. For example, the first crystalline carbon MTR may have a D/G value in a range from about 0.02 to about 0.2. The D/G value may be defined to denote a ratio of D band peak intensity area to G band peak intensity area in a Raman spectrum.

The porous silicon particle PSN may include a plurality of porous silicon particles. For example, the plurality of porous silicon particles may be dispersed in the first crystalline carbon MTR. The first crystalline carbon MTR may surround each of the plurality of porous silicon particles.

The porous silicon particle PSN may include iron (Fe). For example, the porous silicon particle PSN may include an alloy of silicon (Si) and iron (Fe). For example, the silicon-iron alloy may include ferrosilicon.

A concentration of iron (Fe) in the porous silicon particle PSN may be equal to or less than about 13 at %. The concentration of iron (Fe) may be defined to indicate a ratio of the number of iron atoms to a total number of silicon atoms and iron atoms in the porous silicon particle PSN. For example, the concentration of iron (Fe) in the porous silicon particle PSN may range from about 2 at % to about 13 at %. In embodiments, the porous silicon particle PSN according to the present invention may not substantially include iron (Fe). If the porous silicon particle PSN has the aforementioned concentration of iron (Fe), it may be possible to provide a negative electrode active material having excellent capacity.

The porous silicon particle PSN may have a particle diameter in a range from about 5 nm to about 15 nm. For example, the porous silicon particle PSN may have a nano-sized particle diameter. In this description, the term “particle diameter” may refer to a diameter obtained by measuring 30 or more porous silicon particles PSN randomly selected from an electron microscope image of the negative electrode active material. The particle diameter of the porous silicon particle PSN may be uniform (e.g., substantially uniform) within the range above.

The porous silicon particle PSN may have an amount in a range from about 15 wt % to about 65 wt %, from about 15 wt % to about 60 wt %, from about 20 wt % to about 55 wt %, from about 35 wt % to about 55 wt %, from about 40 wt % to about 55wt %, or from about 43 wt % to about 53 wt % relative to the total weight of the negative electrode active material.

If the porous silicon particle PSN has a particle diameter and amount that satisfies the ranges above, it may be possible to provide a negative electrode active material capable of maintaining its structure while having excellent charge-discharge capacity.

The porous silicon particle PSN may include a pore POR. For example, the silicon particle may have a porous structure. The porous silicon particle PSN may include a plurality of pores POR.

The porous silicon particle PSN may have a BET (Brunauer, Emmett, Teller) specific surface area in a range from about 240 m²/g to about 760 m²/g. For example, the BET specific surface area of the porous silicon particle PSN may be determined through BET analysis of a remaining porous silicon particle PSN after treating the negative electrode active material at high temperatures and then oxidizing and removing carbon within the negative electrode active material.

If the porous silicon particle PSN has its structure mentioned above, it may be possible to reduce a volume change that occurs in the procedure of alloying/de-alloying of silicon with lithium during charge and discharge and to maintain a structure of the negative electrode active material.

Referring to FIG. 8, in an embodiment of the present disclosure, the porous silicon particle PSN may include a region RG including a first region RG1 and a second region RG2, and the second region RG2 may surround the first region RG1. The second region RG2 may be defined to express a region having a thickness in a range from about 2 nm to about 5 nm in a direction toward a center from an outermost edge of the porous silicon particle PSN. The first region RG1 may be defined to signify a region other than the second region RG2 in the porous silicon particle PSN.

There may be a variation in a distribution of pores POR in the porous silicon particle PSN. For example, the distribution of a plurality of pores POR per unit area may be greater in the second region RG2 than in the first region RG1.

There may be a variation in a concentration of iron (Fe) in the porous silicon particle PSN. For example, the concentration of iron (Fe) in the porous silicon particle PSN may be less in the second region RG2 than in the first region RG1.

Referring back to FIG. 7, the shell SHL may include a plurality of shells. The shell SHL may include a first shell SHL1 and a second shell SHL2. The first shell SHL1 may include a plurality of first shells. The second shell SHL2 may include a plurality of second shells. The plurality of first shells and the plurality of second shells may be provided alternately with each other. For example, one of the plurality of first shells may be between the core COR and one of the plurality of second shells.

The first shell SHL1 may include amorphous carbon. For example, the amorphous carbon may include at least one selected from non-graphitizable carbon (hard carbon) and graphitizable carbon (soft carbon).

The amorphous carbon may have a D/G value of equal to or greater than about 0.3. For example, the D/G value of the amorphous carbon may range from about 0.3 to about 1.5.

The first shell SHL1 may suppress or reduce a change in volume of the core COR. The first shell SHL1 may permit lithium ions to easily move at an interface between the negative electrode active material and the electrolyte.

The second shell SHL2 may include a second crystalline carbon. The second crystalline carbon may include at least one selected from natural graphite and artificial graphite. For example, the second crystalline carbon may be natural graphite, artificial graphite, or any combination thereof. The second crystalline carbon may be the same as or different from the first crystalline carbon MTR.

The second crystalline carbon may have a D/G value of equal to or less than about 0.2. For example, the D/G value of the second crystalline carbon may range from about 0.02 to about 0.2.

The second shell SHL2 may have mechanical ductility superior to that of the first shell SHL1. For example, the second shell SHL2 may easily be altered by external force, readily shrink, and buffer a volume change of silicon. In embodiments, the second shell SHL2 may have a resistance (e.g., an electrical resistance) less than that of the first shell SHL1.

The shell SHL may have a thickness in a range from about 500 nm to about 6 μm. The shell SHL may have a maximum thickness in a range from about 1 μm to about 6 μm, from about 1.5 μm to about 5 μm, or from about 2 μm to about 4 μm. For example, the maximum thickness of the shell SHL may indicate a value obtained by randomly selecting 100 or more negative electrode active materials from an electron microscope image of the negative electrode active material and measuring a thickness of the thickest part of the shell included in each negative electrode active material. The thickness may be defined as a distance between a first point on an outermost edge of the shell SHL and a second point at a boundary where the core COR meets the shell SHL. The first point may be a contact point where the outermost edge of the shell SHL meets a tangent line at the contact point. The second point may be a point where, if a straight line is drawn in a direction normal to the tangent line from the contact point, the straight line meets the boundary.

As the shell SHL has the structure mentioned above, it may be possible to provide a negative electrode active material capable of easily shrinking, maintaining its structure despite a volume change during charge and discharge, having a low resistance (e.g., a low electrical resistance), and excellent capacity.

he shell SHL may have a D/G value in a range from about 0.2 to about 0.3. For example, the D/G value of the shell SHL including the first shell SHL1 and the second shell SHL2 may be in a range from about 0.2 to about 0.3. In embodiments, the D/G value of the shell including both of the amorphous carbon and the second crystalline carbon may range from about 0.2 to about 0.3. If the D/G value of the shell SHL satisfies the range above, it may be possible to manufacture a negative electrode active material having a suitable or desired structure and composition of the shell SHL.

The core COR and the shell may be distinguished from each other in terms of a component, an amount, a D/G value, and so forth. For example, an amount of the porous silicon particle PSN of the core COR may be greater than that of the porous silicon particle PSN of the shell. An amount of crystalline carbon of the core COR may be greater than that of crystalline carbon of the first shell SHL1. An amount of amorphous carbon of the core COR may be less than that of amorphous carbon of the first shell SHL1.

A negative electrode active material according to some embodiments of the present disclosure and a rechargeable lithium battery including the same may have the following features. The negative electrode active material may have a BET specific surface area in a range from about 1 m²/g to about 10 m²/g. For example, the BET specific surface area of the negative electrode active material may be about 5.2 m²/g. The negative electrode active material may have a porosity in a range from about 5% to about 20%. The negative electrode active material may have a true density in a range from about 2 g/cc to about 5 g/cc. According to some embodiments of the present disclosure, the negative electrode active material may be readily compressible, and may thus be used to easily manufacture a negative electrode.

A rechargeable lithium battery according to some embodiments of the present disclosure may have a low resistance (e.g., a low electrical resistance), a high capacity, an increased charge rate, and a long lifetime. For example, the rechargeable lithium battery may have a discharge rate of equal to or greater than about 1,850 mAh/g. The rechargeable lithium battery may have a charge rate of equal to or greater than about 60%. The rechargeable lithium battery may have a lifetime of equal to or greater than about 80%.

### Manufacture of Negative Electrode Active Material

FIG. 9 is a flow chart showing a method of manufacturing a negative electrode active material according to an embodiment of the present disclosure. FIGS. 10-12 illustrate diagrams showing the method of manufacturing a negative electrode active material.

Referring to FIG. 9, a method of manufacturing a negative electrode active material according to some embodiments of the present disclosure may include mixing a silicon-iron alloy and a hard carbon raw material together to prepare a first mixture (S100), allowing the first mixture to undergo graphitization to prepare a second mixture (S300), and washing the second mixture with an acid (S500).

Referring to FIG. 10, a silicon-iron alloy SFA and a hard carbon raw material HCS may be mixed together to prepare a first mixture MXR1 (S100).

For example, the silicon-iron alloy SFA may include ferrosilicon.

For example, the hard carbon raw material HCS may include at least one selected from lignin, phenolic resin, petroleum-based coal tar pitch, and coal-based coal tar pitch.

The silicon-iron alloy SFA and the hard carbon raw material HCS may have a weight ratio of about 1:1.5 to about 1:11.

A mixer may be used to perform the mixing process. For example, the mixer may include a revolution-rotation-type centrifugal mixer. The revolution-rotation-type centrifugal mixer may be a mixer where both rotation and revolution occur concurrently (e.g., simultaneously) with or without vacuum condition. For example, a rotation agitation speed and a revolution agitation speed may each independently be equal to or less than 2,000 rpm or equal to or less than about 1,000 rpm. The revolution-rotation-type centrifugal mixer may include a planetary mixer or a planetary dispenser mixer. The rotation agitation speed and the revolution agitation speed may be suitably or appropriately adjusted to alternately perform agitation and degassing and to uniformly (e.g., substantially uniformly) mix the components.

For example, the present act S100 may include mixing the silicon-iron alloy SFA, the hard carbon raw material HCS, and a solvent together, and evaporating the solvent of the mixture. For example, the solvent may include water. In embodiments, a dough-like first mixture MXR1 may be prepared.

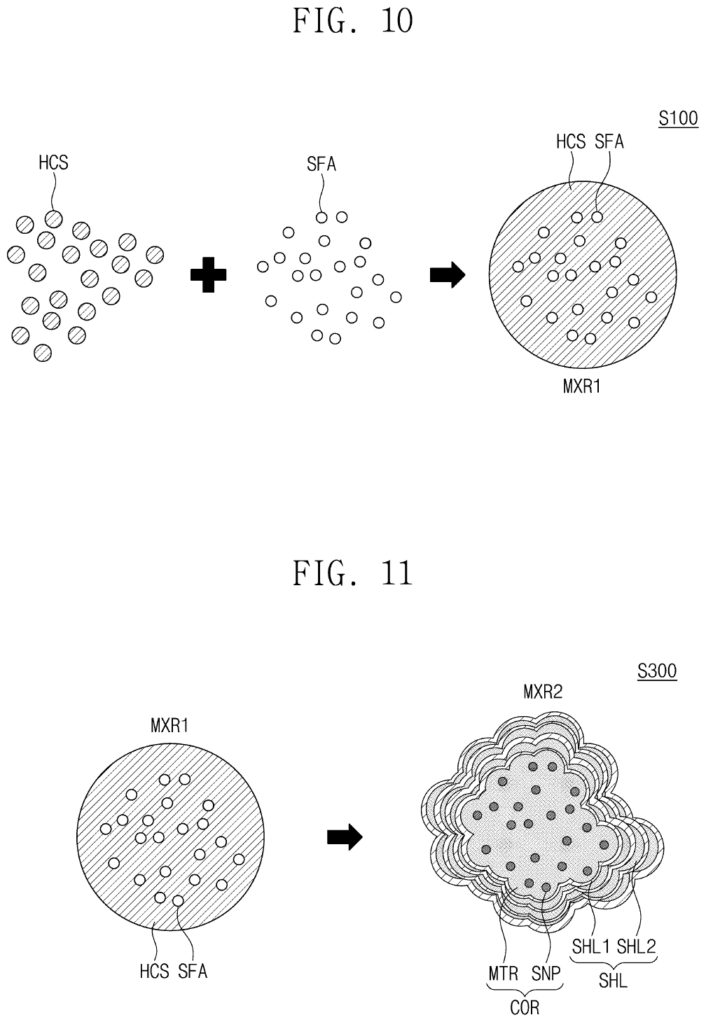

Referring to FIG. 11, the first mixture MXR1 may undergo graphitization to prepare a second mixture MXR2 (S300).

The graphitization may refer to a procedure in which a carbonaceous material is converted into graphite. Thus, crystalline carbon may be prepared. Generally, the graphitization may be performed at a high-temperature condition of about 3,000° C. However, under the temperature above, a carbonaceous material and pure silicon may chemically react with each other to form silicon carbide (SiC). The silicon carbide (SiC) may be an irreversible compound (e.g., may be irreversibly formed) and may not be suitable for use as a negative electrode for a rechargeable lithium battery.

Iron (Fe) included in the silicon-iron alloy SFA may graphitize a carbon raw material at low temperatures. For example, iron (Fe) may serve as a catalyst to graphitize the hard carbon raw material HCS at low temperatures.

In embodiments, the graphitization may be performed at a temperature of less than about 3,000° C. For example, the graphitization temperature may range from about 1,000° C. to about 1,500° C. The silicon-iron alloy SFA including iron (Fe) may be used to prepare crystalline carbon even at low temperatures.

The graphitization may be maintained for 20 minutes to about 3 hours at the above-mentioned temperature range (e.g., about 1,000° C. to about 1,500° C.). For example, the graphitization may be maintained for about 20 minutes to about 3 hours (which may be referred to as the graphitization retention time) at about 1,000° C. to about 1,500° C.

A temperature rising rate (e.g., a temperature increase rate) to the graphitization temperature (about 1,000° C. to about 1,500° C.) may range from about 5° C./min to about 20° C./min. A temperature rising time (e.g., a temperature increase time) to the graphitization temperature (about 1,000° C. to about 1,500° C.) may range from about 1 hour to about 4 hours. For example, the graphitization may include heating to about 1,000° C. to about 1,500° C. for the temperature rising time of about 1 hour to about 4 hours at the temperature rising rate of about 5° C./min to about 20° C./min.

If the temperature rising rate, the temperature rising time, and the graphitization retention time satisfy the ranges above, it may be possible to manufacture a negative electrode active material having a suitable or desired maximum thickness of a shell.

Iron (Fe) in the first mixture MXR1 may promptly graphitize the hard carbon raw material HCS. Thus, the core COR may be formed which includes a first crystalline carbon MTR and a nano-sized silicon-containing particle SNP. The silicon-containing particle SNP may include not only silicon (Si), but also iron (Fe). The silicon-containing particle SNP may include a plurality of silicon-containing particles. For example, the plurality of silicon-containing particles may be dispersed in the first crystalline carbon MTR.

After the formation of the core COR, the first mixture MXR1 may be graphitized to form a shell SHL on the core COR. The first mixture MXR1 may have a portion where iron (Fe) is absent, and the portion may be formed into a first shell SHL1 including an amorphous carbon. The first mixture MXR1 may have a set or certain portion where iron (Fe) is present, and the set or certain portion may be formed into a second shell SHL2 including a second crystalline carbon. The kind of the second crystalline carbon may be as discussed above.

The first shell SHL1 may include a plurality of first shells. The second shell SHL2 may include a plurality of second shells. The plurality of first shells and the plurality of second shells may be provided alternately with each other. For example, one of the plurality of first shells may be between the core COR and one of the plurality of second shells.

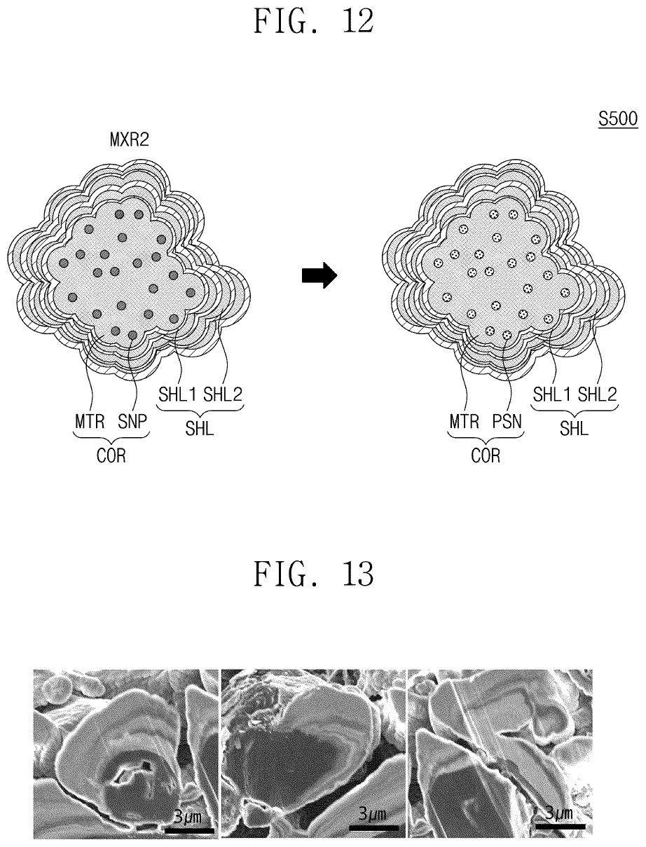

Referring to FIG. 12, the second mixture MXR2 may be washed with an acid (S500).

For example, the acid may include at least one selected from hydrochloric acid, nitric acid, acetic acid, formic acid, succinic acid, citric acid, malic acid, maleic acid, oxalic acid, and any mixture thereof.

The acid may dissolve iron (Fe) in the second mixture MXR2. The acid may enter the second mixture MXR2 to dissolve iron (Fe) in the second mixture MXR2. Thus, it may be possible to melt or dissolve iron (Fe) that does not participate in charge and discharge and to form a pore in the silicon-containing particle SNP. A porous silicon particle PSN may therefore be formed. The pore in the porous silicon particle PSN may remain as an empty space in a finally manufactured negative electrode active material, and may buffer a volume change that occurs in the procedure of alloying/de-alloying of silicon with lithium during charge and discharge and to maintain a structure of the negative electrode active material.

The acid may enter the second mixture MXR2 to form the porous silicon particle PSN illustrated in FIG. 8. There may be a variation in distribution of pores in the porous silicon particle PSN. For example, the distribution of a plurality of pores per unit area may be greater in the second region RG2 than in the first region RG1. In embodiments, there may be a variation in concentration of iron (Fe) in the porous silicon particle PSN. For example, the concentration of iron (Fe) in the porous silicon particle PSN may be less in the second region RG2 than in the first region RG1.

In embodiments, a negative electrode active material may be manufactured as shown in FIGS. 7-8. The negative electrode active material may reduce a structural fracture caused by a variation in volume during charge and discharge, have a low resistance (e.g., a low electrical resistance), and a high capacity per unit material.

After completion of the act S300, the act S500 may be performed to allow the negative electrode active material to have an excellent discharge capacity and a superior charge rate. In embodiments, the negative electrode active material may have a low expansion rate and a long lifetime.

Herein, the subject matter of the present disclosure will be described in more detail with reference to Embodiments. The following Embodiments are provided for illustrative purpose only and are not to be construed to limit the scope of the present disclosure.

### Embodiment 1

A negative electrode active material was manufactured which has a core-shell structure where a core includes crystalline carbon and a plurality of porous silicon particles, and where a shell includes a first shell including amorphous carbon and a second shell including crystalline carbon. A maximum thickness of the shell was about 1 μm to about 6 μm.

Ferrosilicon (FeSi), lignin, and water were mixed together to prepare a first mixture (S100). A weight ratio of ferrosilicon (FeSi) and lignin was about 1:1.7, and an amount of solid content in the first mixture was about 60 wt %. A high-speed stirrer was used to perform the mixing for about 1 hour at about 1,500 rpm.

The first mixture was graphitized to prepare a second mixture (S300). The graphitization was performed under an N₂ environment. First, a temperature was raised to about 1,200° C. for about 2 hours at a temperature rising rate of about 10° C./min, maintained for about 1 hour at about 1,200° C., and then cooled to room temperature.

The second mixture was added to a 35% solution of hydrochloric acid (HCl) to perform an acid washing process (S500). Afterwards, the washed second mixture was washed with distilled water three times and dried (e.g., infrared (IR) oven dried) to obtain the negative electrode active material.

### Comparative Example 1

A negative electrode active material was manufactured according to substantially the same method as in Embodiment 1, except that the act S500 was omitted. Therefore, the negative electrode active material was obtained in which the core includes a silicon-containing particle instead of a porous silicon particle.

### Comparative Example 2

A negative electrode active material was manufactured according to substantially the same method as in Embodiment 1, except that silicon was added instead of ferrosilicon in the act S100 and the act S500 was omitted. Therefore, the negative electrode active material was obtained in which the core includes a silicon-containing particle instead of a porous silicon particle, and in which the shell includes only amorphous carbon.

### Comparative Example 3

First, ferrosilicon was added to a 35% solution of hydrochloric acid (HCl) to perform an acid washing process, washed with distilled water three times, and then dried to prepare porous silicon particles.

A negative electrode active material was manufactured according to substantially the same method as in Embodiment 1, except that the prepared porous silicon particles was added in the act S100 and the act S500 was omitted. For example, the preparation of porous silicon particles was followed by the graphitization. Therefore, the negative electrode active material was obtained in which the core includes a porous silicon particle, and in which the shell includes only amorphous carbon.

### Comparative Example 4

Ferrosilicon was added to a 35% solution of hydrochloric acid (HCl) to perform an acid washing process, washed with distilled water three times, and then dried to prepare the negative electrode active material including porous silicon particles.

### Comparative Example 5

There was manufactured a negative electrode active material including a shell having a maximum thickness of about 9 μm.

The negative electrode active material was manufactured according to substantially the same method as in Embodiment 1, except that, in the act S300, a temperature was raised to about 900° C. for about 0.5 hours at a temperature rising rate of about 30° C./min, and then immediately cooled to room temperature.

### Comparative Example 6

There was manufactured a negative electrode active material including a shell having a maximum thickness of about 381 nm.

The negative electrode active material was manufactured according to substantially the same method as in Embodiment 1, except that, in the act S300, a temperature was raised to about 1,550° C. for about 6 hours at a temperature rising rate of about 4° C./min, maintained for about 5 hours at about 1,550° C., and then cooled to room temperature.

### Fabrication of Rechargeable Lithium Battery

98 wt % of the prepared negative electrode active material, 1 wt % of carboxymethyl cellulose, and 1 wt % of styrene-butadiene rubber were mixed together with distilled water to prepare a slurry. The slurry was coated and dried on a copper (Cu) film, and then roll-pressed to manufacture a negative electrode. 96 wt % of LiCoO₂, 2 wt % of polyvinylidene fluoride (PVdF), and 2 wt % of

carbon black were mixed together with N-Methyl-2-pyrrolidone (NMP) to prepare a slurry, and the slurry was coated and dried on an aluminum (Al) film and then roll-pressed to manufacture a positive electrode.

The negative electrode, the positive electrode, a polyethylene separator, and an electrolyte were used to fabricate a rechargeable lithium battery. 1.5 M LiPF₆ was mixed in an organic solvent including ethylene carbonate (EC), diethyl carbonate (DEC), and dimethyl carbonate (DMC) mixed together in a volume ratio of 2:1:7, and fluoroethylene carbonate (FEC) was added in an amount of 3 parts by weight relative to 100 parts by weight of the organic solvent to obtain the electrolyte.

### Evaluation Example 1: Analysis on Negative Electrode Active Material

FIGS. 13-18 are SEM images showing the negative electrode active materials according to Embodiment 1 and Comparative Examples 1 to 3, 5, and 6. Silicon amounts, specific surface areas, porosities, and true densities of the negative electrode active materials according to the Embodiment and Comparative Examples were measured and the measured results are listed in Table 1 below. The silicon amount is expressed as a percentage of the total weight of the negative electrode active material. The silicon amount was measured using energy dispersive X-ray analysis (EDX). The specific surface area was measured using a gas adsorption method based on the Brunauer-Emmet-Teller (BET) model. The porosity was measured using mercury porosimetry. A measurement apparatus of the porosity was MicroActive AutoPore V 9600 commercially available from Micrometrics Instrument Corporation. The porosity was evaluated by measuring a volume of mercury that changes with pressure if mercury is pressed against the Embodiment and Comparative Examples.

Referring to FIG. 13, the negative electrode active material according to Embodiment 1 had a structure including a core and a shell. The core included crystalline carbon (dark gray portion) and a plurality of porous silicon particles. An amount of the porous silicon particles was 53 wt % relative to the total weight of the negative electrode active material. A size of the core was about 3 μm to about 8 μm.

The shell included a first shell and a second shell. The first shell and the second shell were alternately provided with each other. The first shell included amorphous carbon (light gray portion). The second shell included crystalline carbon (dark gray portion). A maximum thickness of the shell was about 1 μm to about 6 μm.

Referring to FIG. 14, the negative electrode active material according to Comparative Example 1 included a silicon-containing particle instead of the porous silicon particle. For example, it was ascertained that the acid washing process in the act S500 caused the silicon-containing particle to have pores, and that a porous silicon particle was formed.

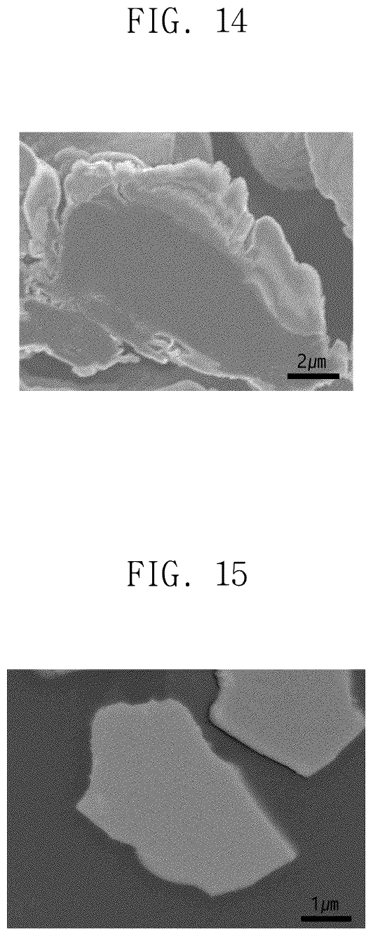

Referring to FIG. 15, the negative electrode active material according to Comparative Example 2 included only a silicon-containing particle and amorphous carbon. For example, in the case of use of silicon instead of silicon-iron alloy, no crystalline carbon was formed within the graphitization temperature in the act S300. It was ascertained that no crystalline carbon was formed without a catalyst within the temperature range.

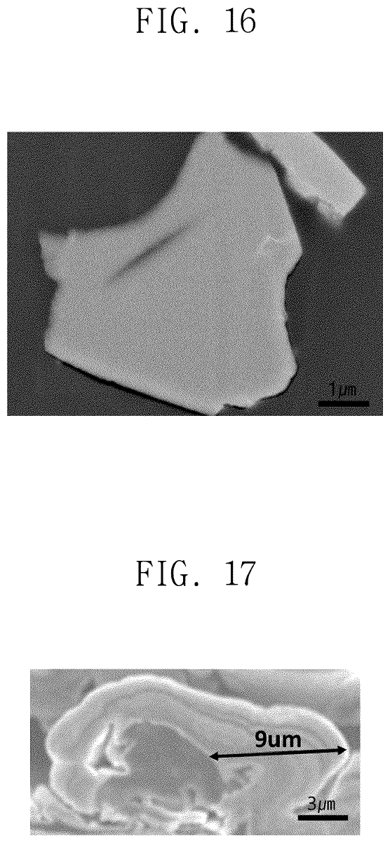

Referring to FIG. 16, it was observed that the negative electrode active material according to Comparative Example 3 included only porous silicon particles and amorphous carbon. For example, it was ascertained that, if porous silicon particles was first prepared and then graphitization was performed, no crystalline carbon was formed because of the absence of a silicon-iron alloy as a catalyst.

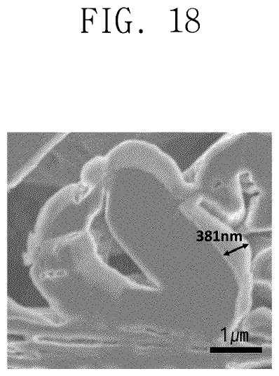

Referring to FIG. 17, a maximum thickness of the shell was greater in the negative electrode active material according to Comparative Example 5 than in the negative electrode active material according to Embodiment 1. The maximum thickness of the shell according to Comparative Example 5 was 9 μm. Referring to FIG. 18, a maximum thickness of the shell was less in the negative electrode active material according to Comparative Example 6 than in the negative electrode active material according to Embodiment 1. The maximum thickness of the shell according to Comparative Example 6 was 381 nm. For example, it was ascertained that, if the temperature rising rate, the temperature rising time, and the graphitization retention time satisfied the ranges above in the act S300, it was possible to manufacture a negative electrode active material having a suitable or desired maximum thickness of the shell.

TABLE 1

| | | | | Specific | | |
|---|---|---|---|---|---|---|
| | Silicon | Raman | Raman | surface | | True |
| | amount | D/G of | D/G of | area | Porosity | density |
| Category | (wt %) | core | shell | (m²/g) | (%) | (g/cc) |
| Embodiment 1 | 53 | 0.03 | 0.26 | 5.2 | 14.3 | 2.1 |
| Comparative | 43 | 0.04 | 0.25 | 2.0 | 2.4 | 2.8 |
| Example 1 | | | | | | |
| Comparative | 54 | 0.91 | 0.88 | 1.9 | 2.1 | 1.9 |
| Example 2 | | | | | | |
| Comparative | 52 | 0.89 | 0.93 | 4.9 | 13.7 | 2.2 |
| Example 3 | | | | | | |
| Comparative | 86 | — | — | 633 | 73 | 2.6 |
| Example 4 | | | | | | |
| Comparative | 53 | 0.05 | 0.26 | 5.5 | 14.8 | 2.0 |
| Example 5 | | | | | | |
| Comparative | 54 | 0.03 | 0.28 | 5.0 | 13.9 | 2.3 |
| Example 6 | | | | | | |

### Evaluation Example 2: Battery Characteristics

Characteristics of the rechargeable lithium batteries that were fabricated with the respective negative electrode active material of the Embodiment and Comparative Examples were evaluated.

The rechargeable lithium battery was initially charged under conditions of constant current (0.2 C), and after resting for 10 minutes, the rechargeable lithium battery was initially discharged under conditions of constant current (0.2 C) until a voltage reached 2.5 V to thereby evaluate a discharge capacity. A lifetime retention rate was evaluated as a ratio of discharge capacity measured after 500 cycles under the same charge-discharge condition and the measured discharge capacity of the first cycle. In addition, a charge rate was evaluated as a ratio of charge capacity measured after charging at 2.0 C and charge capacity measured after charging at 0.2 C. The battery was charged at 0.2 C under the same condition, and disassembled to measure a thickness of the negative electrode, and an expansion rate was evaluated as a ratio of the thickness of the negative electrode and a thickness of the negative electrode before the charge. The evaluation results of battery characteristics are shown in Table 2 below.

TABLE 2

| | Discharge | Charge | Expansion | |
|---|---|---|---|---|
| | capacity | rate | rate | Lifetime |
| Category | (mAh/g) | (%) | (%) | (%) |
| Embodiment 1 | 1853 | 63 | 14 | 83 |
| Comparative | 941 | 42 | 73 | 32 |
| Example 1 | | | | |
| Comparative | 1846 | 17 | 121 | 18 |
| Example 2 | | | | |
| Comparative | 1851 | 24 | 49 | 29 |
| Example 3 | | | | |
| Comparative | 2993 | 11 | 267 | 8 |
| Example 4 | | | | |
| Comparative | 1595 | 26 | 23 | 76 |
| Example 5 | | | | |
| Comparative | 1856 | 45 | 28 | 72 |
| Example 6 | | | | |

Referring to Table 2, the rechargeable lithium battery including the negative electrode active material according to Embodiment 1 has an excellent discharge capacity and a superior charge rate, compare to the rechargeable lithium batteries including the negative electrode active materials according to Comparative Examples 1 to 6. In addition, the rechargeable lithium battery including the negative electrode active material according to Embodiment 1 has a reduced expansion rate and an increased lifetime, compare to the rechargeable lithium batteries including the negative electrode active materials according to Comparative Examples 1 to 6.

Therefore, if using a method of manufacturing a negative electrode active material according to some embodiments of the present disclosure, it may be possible to easily manufacture a negative electrode, to prepare a negative electrode active material having a low resistance (e.g., a low electrical resistance), an excellent capacity, and a long lifetime, and to provide a rechargeable lithium battery including the negative electrode active material.

If using a method of manufacturing a negative electrode active material according to some embodiments of the present disclosure, a negative electrode may be readily manufactured due to its easy shrinkage and to provide a negative electrode active material having a low resistance (e.g., a low electrical resistance) and a reduced structural change caused by a volume variation during charge and discharge.

Moreover, a rechargeable lithium battery according to an embodiment of the present disclosure may have excellent capacity and lifetime characteristics.

Although some embodiments of the present disclosure have been discussed with reference to the accompanying drawings, it will be understood that various suitable changes in form and details may be made therein without departing from the spirit and scope of the present disclosure. It therefore will be understood that the embodiments described above are just illustrative but not limitative in all aspects.

What is claimed is:

1. A method of manufacturing a negative electrode active material, the method comprising:
mixing a silicon-iron alloy and a hard carbon raw material together to prepare a first mixture;
allowing the first mixture to undergo graphitization at about 1,000° C. to about 1,500° C. to prepare a second mixture; and
washing the second mixture with an acid.

2. The method as claimed in claim 1, wherein the silicon-iron alloy comprises ferrosilicon.

3. The method as claimed in claim 1, wherein the hard carbon raw material comprises at least one selected from lignin, phenolic resin, petroleum-based coal tar pitch, and coal-based coal tar pitch.

4. The method as claimed in claim 1, wherein the graphitization is maintained for 20 minutes to about 3 hours at about 1,000° C. to about 1,500° C.

5. The method as claimed in claim 1, wherein the graphitization comprises heating to about 1,000° C. to about 1,500° C. for a temperature rising time of about 1 hour to about 4 hours at a temperature rising rate of about 5° C./min to about 20° C./min.

6. The method as claimed in claim 1, wherein the acid comprises at least one selected from hydrochloric acid, nitric acid, acetic acid, formic acid, succinic acid, citric acid, malic acid, maleic acid, oxalic acid, and any mixture thereof.

7. A negative electrode active material, comprising:
a core that comprises a first crystalline carbon and a porous silicon particle; and
a shell on the core,
wherein a size of the core is in a range of about 1 μm to about 20 μm,
wherein the shell comprises:
a first shell on the core; and
a second shell on the first shell,
wherein the first shell comprises an amorphous carbon, and
wherein the second shell comprises a second crystalline carbon.

8. The negative electrode active material as claimed in claim 7, wherein the porous silicon particle comprises a plurality of porous silicon particles,
wherein the plurality of porous silicon particles are dispersed in the first crystalline carbon.

9. The negative electrode active material as claimed in claim 7, wherein the porous silicon particle comprises iron (Fe),
wherein a concentration of iron in the porous silicon particle is equal to or less than about 13 at %.

10. The negative electrode active material as claimed in claim 7, wherein the porous silicon particle comprises:
a first region; and
a second region that surrounds the first region,
wherein the second region has a thickness of about 2 nm to about 5 nm in a direction toward a center from an outermost edge of the porous silicon particle.

11. The negative electrode active material as claimed in claim 10, wherein the porous silicon particle includes a plurality of pores,
wherein a distribution of the plurality of pores per unit area is greater in the second region than in the first region.

12. The negative electrode active material as claimed in claim 10, wherein the porous silicon particle comprises iron (Fe),
wherein a concentration of iron in the porous silicon particle is less in the second region than in the first region.

13. The negative electrode active material as claimed in claim 7, wherein a particle diameter of the porous silicon particle is in a range of about 5 nm to about 15 nm.

14. The negative electrode active material as claimed in claim 7, wherein an amount of the porous silicon particle is in a range of about 15 wt % to about 65 wt % relative to a total weight of the negative electrode active material.

15. The negative electrode active material as claimed in claim 7, wherein
the first shell comprises a plurality of first shells,
the second shell comprises a plurality of second shells, and
the plurality of first shells and the plurality of second shells are provided alternately with each other.

16. The negative electrode active material as claimed in claim 7, wherein a D/G value of the shell is in a range of about 0.2 to about 0.3.

17. The negative electrode active material as claimed in claim 7, wherein a maximum thickness of the shell is in a range of about 1 μm to about 6 μm.

18. The negative electrode active material as claimed in claim 7, wherein each of the first and second crystalline carbons comprises at least one selected from natural graphite and artificial graphite.

19. The negative electrode active material as claimed in claim 7, wherein the amorphous carbon comprises at least one selected from non-graphitizable carbon (hard carbon) and graphitizable carbon (soft carbon).

20. A rechargeable lithium battery comprising the negative electrode active material as claimed in claim 7.
